(19) United States
(12) Patent Application Publication
(10) Pub. No.: US 2007/0259682 A1
(43) Pub. Date: Nov. 8, 2007

(54) Enhanced uplink power control with gated uplink of control information

(76) Inventors: Jorma Kaikkonen, Oulu (FI); Anna-Mari Vimpari, Oulu (FI); Mads Hintz-Madsen, Oulu (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/796,114

(22) Filed: Apr. 25, 2007

Related U.S. Application Data
(60) Provisional application No. 60/798,881, filed on May 8, 2006.

(51) Int. Cl. H04B 7/00; H04Q 7/20

(52) U.S. Cl. 455/522

(57) ABSTRACT

A method and corresponding equipment by which a wireless communication terminal is able to determine whether to obey or ignore a power change command from a base station, in case of the wireless communication terminal gating its uplink of data or control information to the base station, causing the base station to erroneously base some power control commands on simply noise and interference. A corresponding method for operation of a base station is also provided, and corresponding equipment.

### CROSS REFERENCE To RELATED APPLICATION

Reference is made to and priority claimed from U.S. provisional application Ser. No. 60/798,881 filed 8 May 2006.

### BACKGROUND OF THE INVENTION

1. Technical Field

The present invention pertains to the field of wireless communications. More particularly, the present invention pertains to procedures to be followed by wireless communication terminals in case of gating of transmit power by the wireless communication terminals.

2. Discussion of Related Art

In some wireless communications systems, in particular UMTS (Universal Mobile Telecommunications System) using WCDMA (Wideband Code Division Multiple Access) for the air interface of its UTRAN (UMTS terrestrial radio access network), in order to save power a UE (user equipment) wireless communication terminal could turn its transmit power on and off, i.e. it could gate its transmit power according to a gating pattern among other factors, i.e. according at least in part to a duty cycle having an on period and an off period. Using a UTRAN with WCDMA as an example, a UE sends data and control information (such as pilot bits) to a Node-B of the UTRAN, and the Node-B then estimates the UE uplink quality based on the control information and commands the UE to change its transmit power accordingly. If a UE were to use transmit power gating, there would then be periods of time in which no control information would be transmitted to the Node-B, and correspondingly, there could be periods of time in which the Node-B might issue power change commands based on unreliable quality information. The UE should ignore such commands, but does not know which commands to ignore.

As one example of the use of the invention, consider the gating of DPCCH (Dedicated Physical Control Channel) in UTRAN with WCDMA. In UTRAN, the uplink DPCCH is used by a UE to uplink control bits for use by the Node-B for, among other things, determining power change commands to downlink to the UE, via either F-DPCH (fractional dedicated physical channel) or downlink DPCCH. The uplink DPCCH carries control information generated at Layer 1 (the physical layer) of the WCDMA protocol stack. The layer 1 control information uplinked by the UE includes e.g. specified pilot bits, transmit power control (TPC) commands (for downlink power control), feedback information (FBI), and an optional transport format combination indicator (TFCI). The uplink DPCCH is at present continuously transmitted (even if there is sometimes no data to transmit), and there is one uplink DPCCH for each radio link. The continuous transmission is suitable for circuit-switched services, which typically send continuously. For bursty packet services, however, continuous DPCCH transmission causes quite a large overhead. It is envisioned that DPCCH will therefore be gated. If the uplink DPCCH conveying the control bits used by the Node-B for power control of the UE is gated, the UE should ignore (or use for other than power control) the received TPC (transmit power control) commands corresponding to (i.e. determined by the Node-B based on) the uplink DPCCH transmission gap (i.e. the off period of the duty cycle corresponding to the gating pattern), for the reasons already given. However, there are at present no requirements/standards for a Node-B for the delay of the inner power control loop (the uplink SIR measurement period) and thus, the delay (uplink SIR measurement period) is implementation-dependent. So at present the UE cannot know which TPC commands correspond to uplink DPCCH transmission gaps (even though the UE knows the uplink transmission gap timing). In other words, at present, a UE is not able to determine which time slots that ordinarily would include TPC commands should be ignored for purposes of uplink power control.

What is needed, therefore, is a way for a UE to determine whether to ignore a power change command from a Node-B in case of the UE gating the uplink used by the Node-B to determine the power change commands.

### DISCLOSURE OF INVENTION

Accordingly, in a first aspect of the invention, a method is provided for use by an apparatus included in a user equipment wireless communication terminal communicably coupled to a radio access network, the method comprising: determining whether to ignore any power change command possibly present in a downlink time period of a power control loop based on a delay/timing indicator relating a downlink time period of a power control loop to an uplink time period, wherein the user equipment wireless terminal uplinks data and/or control information to the radio access network according to a gated transmission; and providing to a radio front end a power change control signal corresponding to a power change command in the downlink time period only if it is determined not to ignore any power change command in the downlink time period based on the delay/timing indicator.

In accord with the first aspect of the invention the delay/timing indicator may be specified in a standard in whole or in part, or all or part of the delay/timing indicator may be obtained from a downlink signal.

In a second aspect of the invention, a method is provided for use by an element of a radio access network communicably coupled to a user equipment wireless communication terminal, comprising: obtaining or determining a delay/timing indicator value indicative of one or more components of a time period required to receive a signal from a wireless communication terminal indicating data and/or control information and to then transmit to the wireless communication terminal a corresponding power change command, or indicative of information sufficient for the user equipment terminal to determine whether to obey a power change command because it is based on data and/or control information.

In accord with the second aspect of the invention the method may further comprise providing a signal for communication to the wireless communication terminal conveying the delay/timing indicator.

The invention also provides two computer program products each comprising a memory structure storing respective sets of instructions executable by a computer processor, where the two sets of instructions are for executing a method according to the first aspect of the invention and a method according to the second aspect of the invention, respectively, and it also provides one or more application specific integrated circuits corresponding to the two computer program products.

The invention also provides a user equipment wireless communication terminal and components therefor, operable according to the first aspect of the invention, and a network element, such as a Node-B or a radio network controller, and components therefor, operable according to the second aspect of the invention.

### BRIEF DESCRIPTION OF THE DRAWINGS

The above and other objects, features and advantages of the invention will become apparent from a consideration of the subsequent detailed description presented in connection with accompanying drawings, in which:

FIG. 1A is a block diagram/flow diagram of a user equipment (UE) wireless communication terminal and a Node-B of a radio access network (RAN) communicatively coupled via a radio link including a gated uplink channel and a downlink channel, and showing the RAN wireless communication providing a delay/timing indicator, according to an embodiment of the invention (although in other embodiments a delay/timing indicator is not signaled to a UE, but is instead standardized and a UE is provided/configured according to the standard).

FIG. 1B is a reduced block diagram (only portions relevant to the invention being shown) of the UE terminal or the Node-B of FIG. 1A.

FIG. 2 is a flow chart of the operation of the UE of FIG. 1A, according to the embodiment of the invention depicted in FIG. 1A.

FIG. 3 is a flow chart of the operation of the Node-B or the radio network controller (RNC) of FIG. 1A, according to the embodiment of the invention depicted in FIG. 1A.

### DETAILED DESCRIPTION

The invention provides a method by which a UE wireless communication terminal, communicatively coupled to a Node-B/base transceiver station of a radio access network of a cellular telephone system (such as a third-generation cellular telephone system), determines whether to ignore a power change command from the Node-B in a downlink of a power control loop because of the UE gating the uplink of the power control loop, conveying data and control information (e.g. pilot bits) used by the Node-B to determine power change commands (and so the power change command may be based on noise and interference, as explained above). The UE is said here to use a gated transmission, i.e. there are gaps in the transmission of the data and/or control information by the UE. Even though there is an underlying gating pattern that dictates when a gap is to occur, sometimes a UE may transmit data and/or control information even during a time period that would fall into a gap according to the gating pattern because a standard may require it. For example, a UE may be required to uplink data and/or control information anytime the UE is to make an E-DCH or HS-DPCCH transmission, even if the data and/or control information would be uplinked in a time period (i.e. e.g. a slot of the DPCCH) falling in a gap (an off period) according to the gating pattern. So the actual activity pattern of a UE uplinking data and/or control information according to a gated transmission is not necessarily regular.

When the UE uplinks the control information used by the Node-B to figure power change commands, there is a propagation delay before the information reaches the Node-B, called here an uplink propagation delay. There is a corresponding downlink propagation delays (which is the same as the uplink propagation delay, if the UE is not moving). The UE sometimes knows these delay (from measurements the UE makes, measurements that are not the subject of the invention), but sometimes does not. Often though, the Node-B knows the propagation delays. In addition to the propagation delays, there is a period of time needed by the Node-B to determine a value for a quality indicator based on the received uplink, a quality indicator such as a SIR (signal to interference ration) value, which the Node-B then uses as a basis for determining what if any power change command to issue to the UE. Then there is a period of time before the Node-B downlinks the power change command (i.e. a period in which other processing is performed ancillary to the SIR measurement and required to provide the downlink signal). The UE does not know the latter two periods of time, and so does not know, without the invention, what uplink slot the Node-B used to determine the power change command. (The UE often does know, and can take into account, the time it takes for the power change command to reach the UE from the Node-B, though.) In other words, the UE does not know, without the invention, whether the uplink slot the Node-B used to determine a power change command contained actual data and control information transmitted by the UE or only noise and interference. Without knowing whether a power change command is based on actual data and control information, the UE cannot easily determine whether the power change command should be obeyed or ignored. If the UE were to obey a power change command based on noise and interference (which would be a command to increase transmit power), the UE would transmit at an unnecessarily high power, causing unnecessary interference to communications and wasting UE power.

To prevent a UE from obeying power change commands it should ignore, the UE is provided with what is here called delay/timing indicator. In some embodiments, a delay/timing indicator is signaled to the UE. In other embodiments the UE is configured per a standard so as to obey only certain power change commands, namely those based on an uplink of actual control and/or data bits to the Node-B. In these other embodiments then, the UE in effect obtains the delay/timing indicator by virtue of the UE being configured according to the standard. Thus, the delay/timing indicator should be understood broadly, as encompassing any information indicating generally the uplink and downlink slot correspondence in the power control loop, i.e. information sufficient for a UE to determine in which slots any TPC command should be ignored or obeyed.

In general, the time between a UE sending data and control information to a Node-B in an uplink slot and the UE receiving a power change command in a downlink slot based on the information in the uplink slot includes: the uplink propagation delay (time to reach the Node-B), a time period—called here a Node-B processing time—for the Node-B to measure the SIR and determine a power change command and then transmit the power change command to the UE, and finally, the downlink propagation time (the time for the power change command transmitted by the Node-B to reach the UE). The total time period between the UE uplinking a slot and receiving a corresponding power change command in a downlink slot is called here the uplink power control delay.

The uplink power control delay is thus a multi-component time period, including uplink and downlink propagation delays, and also the quality measurement and ancillary processing time in the Node-B. As explained above, depending on implementation, sometimes some of the components of the uplink power control delay are known to the UE—and in particular sometimes the uplink and downlink propagation delays are known—and sometimes none are known to the UE. In general, the UE does not know the quality measurement time period, because it is not prescribed by a standard.

As mentioned then, according to some embodiments of the invention, a Node-B in communication with a UE signals to the UE a delay/timing indicator indicating components of the uplink power control delay not known or knowable to the UE, e.g. not prescribed by a standard. (A UE could perhaps suspect a power control command as based on unreliable information on the basis of the command being one in a string of consecutive commands to increase power, at the same time as the UE measures a relatively high SIR value for the Node-B signal, but the UE cannot tell for sure.) The UE then uses the delay/timing indicator in combination with the uplink and downlink times (and any other known components of the uplink power control delay) to determine whether the power change command is based on a transmission of data and control information to the Node-B, and if not (so that it is instead based on only noise and interference), then the UE does not obey the command, but instead ignores it, waiting for a later command and keeping its power at the same level as previous to receiving the command based on the off period of the duty cycle. The Node-B may signal the delay/timing indicator under the direction of its RNC, or it may do so autonomously. The delay/timing indicator need only be signaled once, and can therefore be sent in a message associated with the setup of communications via the Node-B (at call set up, or at one or another sort of handoff to the Node-B).

Take as an example a case in which the UE knows the propagation delays (for both uplink and downlink) and those delays are not indicated by the delay/timing indicator. To determine whether to obey a power change command in such a case, the UE could simply add to the components of the uplink power control delay indicated by the delay/timing indicator the uplink and downlink times known to the UE, and determine, based on when the power change command was received, the uplink slot the power change command was based on, and then, since the UE knows how it gates the uplink of control and/or data for use by the Node-B in determining TPC commands, the UE could determine whether the Node-B used actual data and/or control information (such as pilot bits) in determining the power change command.

In case the Node-B is able to determine whether the uplink slot it is using contains only noise and interference, in some embodiments the Node-B can use the downlink slot not for a power change command, which would be ignored according to the invention, but can instead signal other information or commands to the UE using the downlink slot. Thus, instead of simply obeying or ignoring the bits communicated by the Node-B in a downlink slot corresponding to an uplink slot in which only noise and interference are present because of gating, the UE could use the bits that would otherwise convey power change command as indicative of some other information or command, in case the Node-B can determine how the UE is gating the uplink of the power control loop (i.e. the uplink of the data and/or control information for use by the Node-B in determining TPC commands), and so does not transmit power change command bits based on the off period of the uplink gating, but instead downlinks other bits.

In WCDMA, the UE synchronizes its receiver to the signal from the Node-B and thus implicitly also knows the uplink and downlink propagation delays since the UE knows when it is transmitting in uplink. Also, the combined uplink and downlink propagation delay is often much less than 1/10 of a slot, so the propagation delay often does not add any extra uncertainty as to which uplink slot the power control command in downlink corresponds to. Thus the propagation delays typically need not be indicated by the delay/timing indicator, and thus, according to at least some embodiments of the invention, are not indicated by the delay/timing indicator.

In general, in some embodiments, to determine whether to obey a power change command, the UE backs up in time from the time of receipt of the command a value equal to the propagation delays, the quality measurement time period, and the ancillary Node-B processing time, some or all of which time periods are indicated by the delay/timing indicator signaled to the UE (in these embodiments), to determine the time at which the UE would have uplink data and control information upon which the Node-B would have based the power change command. If the time so determined falls in a time period of the uplink when the UE has gated off (turned off) its uplink power control transmit power, then the UE ignores the command, and otherwise obeys it.

As explained above, depending on implementation sometimes some of the components of the uplink power control delay are known to the UE, which can be achieved in whole or in part through standardization, and sometimes the parts not known can be ignored (the propagation delays and even the processing time needed by the Node-B). In some embodiments where the UE is implemented according to standardization, the uplink power control delay indicator can indicate only the additional information—beyond information provided by the standardization—needed to ignore a TPC command, or equivalently, to determine whether a TPC command is based on an uplink slot not conveying an actual transmission (i.e. instead only noise and interference). In other embodiments, the UE is configured per a standard so as to cause the UE to ignore those TPC commands not based on actual control and/or data bits and so (in these embodiments) there is no need for any signaling of the delay/timing indicator.

Also, in some embodiments only the Node-B may be standardized, not the UE. In that case, the delay/timing indicator must indicate more information, and in particular the information provided by the standardization of the Node-B.

To minimize computation by a UE in determining whether a TPC command should be obeyed or ignored because of UE gating the data and/or control information used for uplink power control, the delay/timing indicator can be provided as what is here called an F-DPCH (or similar downlink channel) ignore pattern (or what might also be called an ignorance pattern). An ignore pattern, as that terminology is used here, is to be understood as any information that at least implicitly indicates the uplink power control delay by providing to the UE the timing correspondence between uplink and downlink transmission for uplink power control loop operation. At one extreme, an ignore pattern could be information indicating e.g. that any TPC command for the UE in every 2^{nd}, 3^{rd}, and 5^{th} time slot in any radio frame of 15 time slots (where 15 slots make up one 10 ms radio frame, every three slots of which form a 2 ms sub-frame) is to be ignored (and the others obeyed). But an ignore pattern would not necessarily expressly indicate every time slot to be ignored (or instead every time slot having a TPC command that should be obeyed) For example, an ignore pattern could indicate only the uplink/downlink time slot correspondence in the power control loop.

As explained, the invention also encompasses the delay/timing indicator (including an ignore pattern) being provided to a UE not by a Node-B, but in effect via a standard, i.e. a UE could be implemented according to a standard that specifies e.g. the SIR measurement timing, i.e. a standard that prescribes the time delay between when a Node-B receives an uplink DPCCH transmission and when it must provide a TPC command based on that transmission, or at least causes the UE to ignore those power change commands not based on data and/or control bits uplinked by the UE.

Another possibility is for a standard to specify when an SIR measurement is to be provided by a UE, i.e. the gating pattern, in which case the Node-B could be implemented consistent with the same standard and so as not to provide TPC commands in a downlink slot corresponding to an uplink DTX slot. For example, Node-Bs could be implemented so as to assume that when gating is enabled, a UE uses SIR measurement timing consistent with the uplink/downlink slot timing in power control specified in 3GPP TS 25.214 (at 5.1.2.2.1). A Node-B could then provide no TPC command in a downlink slot corresponding to an uplink slot it would determine does not provide an SIR measurement per the standard, i.e. the (downlink) F-DPCH (conveying the TPC commands) could be gated to correspond to the (uplink) gating by the UE. (In such an embodiment, the UE would obey all TPC commands it receives from the Node-B, because all would be based on actual control and data uplinked by the UE.)

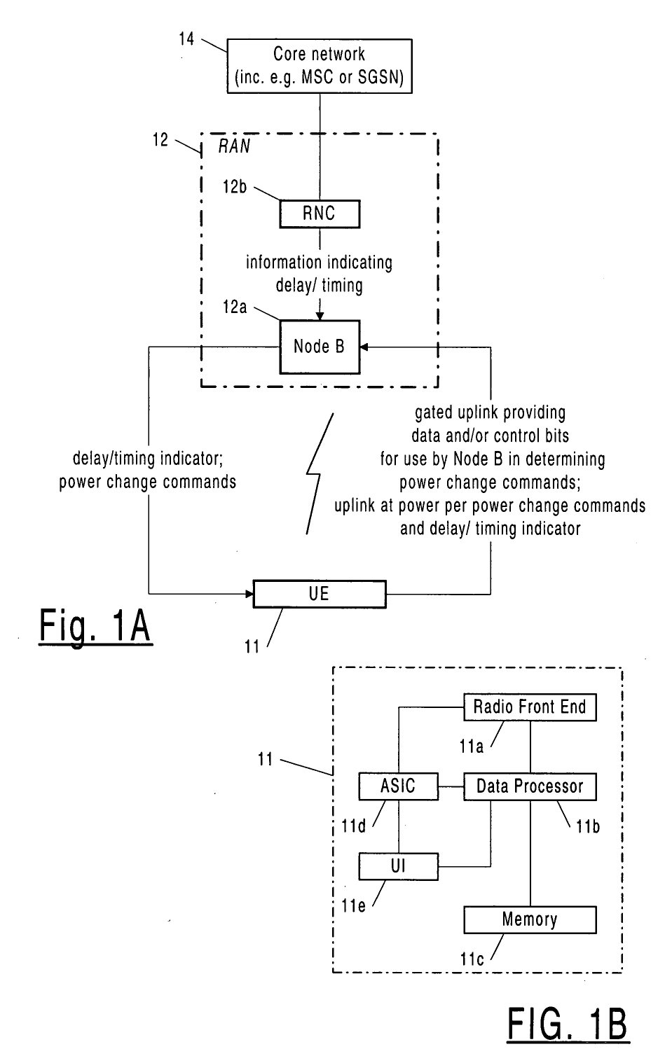

Referring now to FIG. 1A, an embodiment of the invention is illustrated in which a Node-B signals to a UE a delay/timing indicator useable by the UE in determining whether to obey a power change command (and so as opposed for example to an embodiment in which the UE is configured per a standard so as to obey only some power change commands). As shown there, a UE 11 and a Node-B 12a are shown communicatively coupled via a radio link including a gated uplink channel and a downlink channel. The UE provides data and/or control bits used by the Node-B in determining power change commands. The Node-B is shown providing the power change commands, but also providing a delay/timing indicator indicating at least the components of the uplink power control delay not known to the UE, for use by the UE in determining whether a power change command is based on uplinked data and/or control bits, or just noise and interference. The Node-B is a wireless terminal component of a RAN 12, also including a RNC 12b for controlling the Node-B in some respects. In the embodiment illustrated in FIG. 1A, the Node-B is shown receiving the delay/timing indicator from the RNC. The uplink power control indicator could be sent at any time during the communicative coupling of the UE to the Node-B, including at call/session setup or handover, and so independently of whether a UE is in fact gating its uplink in any respect. Note that as mentioned, other embodiments of the invention encompass a UE being provided with a delay/timing indicator not by a Node-B, but by virtue of the UE being configured according to a standard, i.e. by virtue of the UE being implemented according to the standard (and the Node-B being implemented consistent with the standard, as appropriate).

FIG. 1B shows some components of the UE 11. As illustrated, the UE includes a suitable radio front end 11a (including a wireless transceiver, not shown) coupled to a data processor 11b that in turn is coupled to a (volatile and/or non-volatile) memory structure 11c. The data processor can be for example a microprocessor, i.e. a programmable digital electronic component that incorporates the functions of a central processing unit on a single semiconducting integrated circuit. The radio front end may include a digital signal processor (not shown), or the data processor 11b may provide digital signal processing in respect to signals transmitted or received by the wireless terminal. The memory structure 11c stores program code that is executable by the processor 11b, including program code that is provided to implement all or part of the invention. The UE 11, as shown, can also include one or more application specific integrated circuits 11d, for providing some or all of the functionality of the UE, as an alternative to providing the functionality via stored instructions executed by the processor. Finally, the UE 11, as shown, includes a user interface (UI) 11e (usually including, among other things, a display, a keypad, a microphone, and a speaker), coupled to the data processor and possibly also to one or more of one or more ASICs.

Although not illustrated in the drawings, it will be appreciated that each Node-B 12a also includes a radio front end and a data processor and a memory structure and may include one or more ASICs coupled as shown in FIG. 1B, and the RNC 12b also includes a data processor and a memory structure and possibly one or more ASICs.

In general, the various embodiments of the UE 11 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

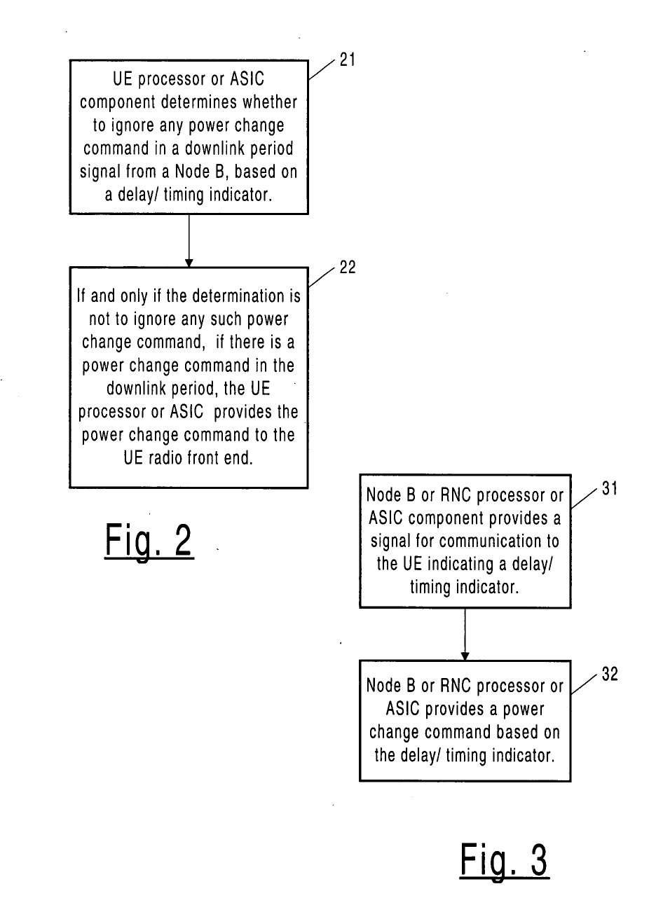

Referring now to FIG. 2, the operation of a UE according to an embodiment of the invention is shown as including a step 21 in which the UE, and more specifically typically a layer one implementation of a protocol stack in the UE but at any rate the processor 11b or the ASIC 11d (FIG. 1B), determines whether any power change command in a time slot (of e.g. the F-DPCH or a similar downlink channel) received from the serving Node-B (or another Node-B in communication with the UE during e.g. a soft handover) is to be ignored (or equivalently, whether it would be based only on noise and interference, as opposed to data and/or control bits transmitted by the UE), and does so using a delay/timing indicator provided by the Node-B or (in effect) indicated by a standard. (There may or may not be a power change command in the time slot.) If and only if the UE determines that any power change command in the time slot should not be ignored (because it would have been determined by the Node-B based on actual control and/or data uplinked by the UE) and assuming that there is a power change command in the time slot, then in a next step 22, the UE processor 11b or ASIC 11d signals the power change command to the radio front end 11a (FIG. 1).

Referring now to FIG. 3, the operation of either a Node-B and/or a RNC according to an embodiment of the invention is shown as including a step 31 in which the Node-B or RNC obtains or determines a delay/timing indicator. Except for the propagation delay components of the uplink power control delay in its entirety, values for the components not indicated by the delay/timing indicator could be programmed or stored in a data store of the Node-B or RNC, in which case the Node-B or RNC would obtain the stored components and include them in the delay/timing indicator. The Node-B or RNC could be programmed to determine by one or another measurement the components that are not stored and not able to be determined by the UE. In other words, in embodiments in which the Node-B itself (as opposed to the RNC) obtains or determines the delay/timing indicator, the Node-B could determine at least some components to be indicated by direct measurement, including timing the period for making the quality measurement and performing the ancillary processing, and making measurements or analyzing uplinked data and control information. In other embodiments, the values for at least some components to be indicated by the delay/timing indicator (not the propagation delays, though) can be predetermined at implementation and stored in the Node-B. In still other embodiments, the components could be provided to the Node-B via a standard, i.e. the Node-B could be implemented according to a standard, in which case the values of the components could be determined or inferred by the Node-B without actual measurement and without necessarily having to be stored.

In a next step 32, the Node-B or RNC provides a signal indicating the delay/timing indicator for transmission to the UE wireless communication terminal via the radio front end (not shown) of the Node-B. In other embodiments, those in which the delay/timing indicator is in effect provided by a standard, there could be no actual signaling of a delay/timing indicator, but instead operation by the Node-B consistent with the standard, and an assumption by the UE that the Node-B operates according to the standard. Alternatively, the Node-B could be implemented according to a standard and so the Node-B would not need to perform a measurement to determine a delay/timing indicator, but the Node-B could still signal the delay/timing indicator to the UE, in case the UE is not implemented per the standard.

If the RNC obtains the delay/timing indicator, it provides it to the Node-B via a (typically wireline) signal, and the Node-B then provides a corresponding (wireless) signal to the UE, thus enabling the UE to determine which power change commands from the Node-B to obey and which to ignore (for purposes of power control).

In case of uplink DPCCH gating being enabled for a UE (in UTRAN), the delay/timing indicator needed by the UE to distinguish between TPC commands to be obeyed versus those to be ignored should be provided to the UE by the Node-B (perhaps under the direction of the RNC), or provided in effect through standardization, as explained above.

A delay/timing indicator according to the invention also encompasses a value that would be communicated to the UE (or known via a standard) indicating how long the UE is to wait for the next TPC command that should be obeyed, to serve as a post-amble indicator. Thus, in case of uplink DPCCH gating by the UE, in case where F-DPCH starts at the same time as the uplink DPCCH, the delay/timing indicator could be interpreted as an indication of how long the UE is to wait for a valid TPC command (enough time for the Node-B to receive the F-DPCH data or control and determine a TPC command, and then transmit the command back to the UE). The UE could then be required to listen in downlink for a TPC command for a time according to the delay/timing indicator. (This assumes that the propagation delay can be neglected, or that the Node-B has somehow included it in the delay value.)

As an alternative, the delay/timing indicator could serve not as a post-amble length indicator, but as a preamble length indicator. Thus, again in case where F-DPCH would otherwise start at the same time as the uplink DPCCH, the UE could be required to start transmitting uplink DPCCH earlier by a time corresponding to or related to the delay/timing indicator. (This again assumes that the propagation delay can be neglected, or that the Node-B has somehow included it in the delay value.)

The delay/timing indicator could be Node-B specific, such as e.g. in a multi-vendor environment. The invention encompasses embodiments especially of use in such situations, embodiments in which the RNC informs all of its Node-B's of a minimum delay to be used that would affect the delay/timing indicator, and a common uplink power control delay could thereby be derived and signalled to the UE's in communication with the Node-B's from different vendors.

In general, though, as already explained, the delay/timing indicator, is to be understood broadly, as encompassing any information indicating generally the uplink and downlink slot correspondence in the power control loop, i.e. information sufficient for a UE to determine in which slots any TPC command should be ignored or obeyed.

It is to be understood that the above-described arrangements are only illustrative of the application of the principles of the present invention. Numerous modifications and alternative arrangements may be devised by those skilled in the art without departing from the scope of the present invention.

What is claimed is:

1. A method for use by an apparatus included in a user equipment wireless communication terminal communicably coupled to a radio access network, comprising:
determining whether to ignore any power change command possibly present in a downlink time period of a power control loop based on a delay/timing indicator relating a downlink time period of a power control loop to an uplink time period, wherein the user equipment wireless terminal uplinks data and/or control information to the radio access network according to a gated transmission; and
providing to a radio front end a power change control signal corresponding to a power change command in the downlink time period only if it is determined not to ignore any power change command in the downlink time period based on the delay/timing indicator.

2. A method as in claim 1, wherein the delay/timing indicator is specified in a standard in whole or in part.

3. A method as in claim 1, further comprising obtaining all or part of the delay/timing indicator from a downlink signal.

4. A method as in claim 1, wherein the delay/timing indicator is a value or values indicating a delay between arrival of the data or control information by the radio access network and transmission of a power change control signal.

5. A method as in claim 1, wherein the delay/timing indicator indicates an uplink and downlink time period correspondence in the power control loop.

6. A method as in claim 1, wherein the delay/timing indicator indicates in which downlink time periods any power change commands should be ignored and/or which are to be obeyed after an uplink transmission gap.

7. A method as in claim 1, wherein the data and/or control information is uplinked on an enhanced dedicated channel by the user equipment wireless communication terminal.

8. A method as in claim 1, wherein the data and/or control information is uplinked on a dedicated control channel by the user equipment wireless communication terminal.

9. A method as in claim 1, wherein the data and/or control information is uplinked according at least in part to a gating pattern of on and off periods during which the user equipment wireless communication terminal transmits and does not transmit, respectively.

10. A method as in claim 1, wherein the delay/timing indicator provides a value for at least some of the time period between uplink of a slot conveying data or control information and downlink of a slot providing a power change command based on the uplinked slot.

11. A method as in claim 1, wherein the delay/timing indicator provides a value for a period of time for measuring quality based on the data and/or control information uplinked by the user equipment and also ancillary processing for preparing and transmitting a corresponding power change command, but not also a value for propagation delay.

12. A method as in claim 1, wherein the delay/timing indicator indicates periods of time in which the power control commands are either not provided or are provided but not based on data and/or control information from the user equipment.

13. A computer program product comprising a computer readable storage structure embodying computer program code thereon for execution by a computer processor, wherein said computer program code comprises instructions for performing a method according to claim 1.

14. An application specific integrated circuit provided so as to operate according to a method as in claim 1.

15. An apparatus, for use in a user equipment wireless communication terminal communicably coupled to a radio access network, comprising a physical layer implementation of a protocol stack of the user equipment wireless communication terminal, configured to:
determine whether to ignore any power change command possibly present in a downlink time period of a power control loop based on a delay/timing indicator relating a downlink time period of a power control loop to an uplink time period, wherein the user equipment wireless terminal uplinks data and/or control information to the radio access network according to a gated transmission; and
provide to a radio front end a power change control signal corresponding to a power change command in the downlink time period only if it is determined not to ignore any power change command in the downlink time period based on the delay/timing indicator.

16. An apparatus as in claim 15, wherein the delay/timing indicator is specified in a standard in whole or in part.

17. An apparatus as in claim 15, wherein the physical layer implementation of the protocol stack is further configured to obtain all or part of the delay/timing indicator from a downlink signal.

18. An apparatus as in claim 15, wherein the delay/timing indicator indicates an uplink and downlink time period correspondence in the power control loop.

19. An apparatus as in claim 15, wherein the delay/timing indicator indicates in which downlink time periods any power change commands should be ignored and/or which are to be obeyed after an uplink transmission gap.

20. An apparatus, for use in a user equipment wireless communication terminal communicably coupled to a radio access network, comprising:
means for determining whether to ignore any power change command possibly present in a downlink time period of a power control loop based on a delay/timing indicator relating a downlink time period of a power control loop to an uplink time period, wherein the user equipment wireless terminal uplinks data and/or control information to the radio access network according to a gated transmission; and
means for providing to a radio front end a power change control signal corresponding to a power change command in the downlink time period only if it is determined not to ignore any power change command in the downlink time period based on the delay/timing indicator.

21. An apparatus as in claim 20, wherein the delay/timing indicator is specified in a standard in whole or in part.

22. An apparatus as in claim 20, further comprising means for obtaining all or part of the delay/timing indicator from a downlink signal.

23. A user equipment wireless communication terminal, comprising:
an apparatus as in claim 15; and
a transceiver for communicatively coupling with the radio access network, and configured to transmit to the radio access network.

24. A user equipment wireless communication terminal, comprising:
a radio front end;
a processor communicably coupled to the radio front end; and
a memory coupled to the processor for storing a set of instructions, executable by the processor, wherein the instructions comprise:
determining whether to ignore any power change command possibly present in a downlink time period of a power control loop based on a delay/timing indicator relating a downlink time period of a power control loop to an uplink time period, wherein the user equipment wireless terminal uplinks data and/or control information to the radio access network according to a gated transmission; and
providing to a radio front end a power change control signal corresponding to a power change command in the downlink time period only if it is determined not to ignore any power change command in the downlink time period based on the delay/timing indicator.

25. A method for use by an element of a radio access network communicably coupled to a user equipment wireless communication terminal, comprising:
obtaining or determining a delay/timing indicator value indicative of one or more components of a time period required to receive a signal from a wireless communication terminal indicating data and/or control information and to then transmit to the wireless communication terminal a corresponding power change command, or indicative of information sufficient for the user equipment terminal to determine whether to obey a power change command because it is based on data and/or control information.

26. A method as in claim 25, further comprising:
providing a signal for communication to the wireless communication terminal conveying the delay/timing indicator.

27. A computer program product comprising a computer readable storage structure embodying computer program code thereon for execution by a computer processor, wherein said computer program code comprises instructions for performing a method according to claim 25.

28. An application specific integrated circuit provided so as to operate according to a method as in claim 25.

29. An apparatus, for use by an element of a radio access network communicably coupled to a user equipment wireless communication terminal, comprising a processor, configured to:
obtain or determining a delay/timing indicator value indicative of one or more components of a time period required to receive a signal from a wireless communication terminal indicating data and/or control information and to then transmit to the wireless communication terminal a corresponding power change command, or indicative of information sufficient for the user equipment terminal to determine whether to obey a power change command because it is based on data and/or control information.

30. An apparatus as in claim 29, wherein the processor is further configured to:
provide a signal for communication to the wireless communication terminal conveying the delay/timing indicator.

31. An apparatus, for use by an element of a radio access network communicably coupled to a user equipment wireless communication terminal, comprising:
means for obtaining or determining a delay/timing indicator value or values indicative of one or more components of a time period required to receive a signal from a wireless communication terminal indicating data and/or control information and to then transmit to the wireless communication terminal a corresponding power change command.

32. An apparatus as in claim 31, further comprising:
means for providing a signal for communication to the wireless communication terminal conveying the delay/timing indicator.

33. A base station of a radio access network, comprising:
an apparatus as in claim 29; and
a radio front end, for communicatively coupling to a user equipment wireless communication terminal.

34. A controller of a radio access network also including a base station controlled by the controller, comprising:
an apparatus as in claim 29; and
a transmitter, for communicatively coupling to the base station.

35. A base station of a radio access network, comprising:
an apparatus as in claim 29; and
a radio front end, for communicatively coupling to a user equipment wireless communication terminal, responsive to the delay/timing indicator, configured to transmit the delay/timing indicator to the user equipment wireless communication terminal.

36. A controller of a radio access network also including a base station controlled by the controller, comprising:
an apparatus as in claim 29; and
a transmitter, for communicatively coupling to the base station, configured to transmit the delay/timing indicator to the base station for delivery to the user equipment wireless communication terminal.
